(19) United States
(12) Patent Application Publication
(10) Pub. No.: US 2026/0116105 A1
(43) Pub. Date: Apr. 30, 2026

(54) RECORDING APPARATUS

(71) Applicant: SEIKO EPSON CORPORATION, Tokyo (JP)

(72) Inventors: Satoshi NAKATA, MATSUMOTO-SHI (JP); Masanari TANAKA, SHIOJIRI-SHI (JP); Kanji MOMOSE, MATSUMOTO-SHI (JP)

(21) Appl. No.: 19/369,586

(22) Filed: Oct. 27, 2025

(30) Foreign Application Priority Data
Oct. 29, 2024 (JP) 2024-189881

(51) Int. Cl. B41J 29/13; B41J 2/17; B41J 3/44

(52) U.S. Cl. CPC B41J 29/13; B41J 2/1721; B41J 3/44

(57) ABSTRACT

A recording apparatus includes a recording portion, a loading portion into which a waste liquid storing body is loadable, and a first maintenance cover displaceable between a non-cover position and a cover position when caused to slide in a first direction. The first maintenance cover includes an operation portion movable in the first direction and the direction opposite to the first direction, and an engager engageable with an engagement receiver of the loading portion. The engager moves to an engagement position at which the engager is engageable with the engagement receiver when the operation portion is moved in the first direction, and moves to a non-engagement position at which the engager is allowed to disengage from the engagement receiver when the operation portion is moved in the direction opposite to the first direction.

The present application is based on, and claims priority from JP Application Serial Number 2024-189881, filed October 29, 2024, the disclosure of which is hereby incorporated by reference herein in its entirety.

### BACKGROUND

### 1. Technical Field

The present disclosure relates to a recording apparatus such as a printer.

### 2. Related Art

There is a printer that is an example of a recording apparatus that performs recording by ejecting ink that is an example of liquid from a recording head that is an example of a recording portion, as described, for example, in JP-A-2012-179729. The recording apparatus includes a maintenance unit and a rear side unit that is an example of a cover. The maintenance unit discharges the ink sucked from the recording head as waste liquid to a waste liquid unit that is an example of a waste liquid storing body. The waste liquid unit can be replaced by removing the rear side unit.

JP-A-2012-179729 is an example of the related art.

The rear side unit described in JP-A-2012-179729 can be detached by pushing an operation button to release the locked rear side unit. In JP-A-2012-179729, however, the direction in which the rear side unit is attached and detached differs from the direction in which the operation button is pushed, so that it is difficult to attach and detach the rear side unit.

### SUMMARY

A recording apparatus according to an aspect of the present disclosure includes a recording portion configured to perform recording on a medium; a loading portion having a loading space into which a loaded member is loadable; and a cover displaced from a non-cover position at which the cover does not cover the loading space to a cover position at which the cover covers the loading space when caused to slide in a first direction, and displaced from the cover position to the non-cover position when caused to slide in a direction opposite the first direction, the cover includes an operation portion movable in the first direction and the direction opposite the first direction when externally operated, and an engager engageable with an engagement receiver provided in the loading portion, and the engager moves to an engagement position at which the engager is engageable with the engagement receiver when the operation portion is moved in the first direction, and moves to a non-engagement position at which the engager is not engageable with the engagement receiver when the operation portion is moved from the engagement position in the direction opposite the first direction.

A recording apparatus according to another aspect of the present disclosure includes a recording portion configured to perform recording on a medium; a loading portion having a loading space into which a loaded member is loadable; and a cover displaced from a non-cover position at which the cover does not cover the loading space to a cover position at which the cover covers the loading space when caused to slide in a first direction, and displaced from the cover position to the non-cover position when caused to slide in a direction opposite the first direction, the cover includes an operation portion movable to a locked position and an unlocked position when externally operated, and an engager engageable with an engagement receiver provided in the loading portion, the engager is located at an engagement position at which the engager is engageable with the engagement receiver when the operation portion is located at the locked position, and is located at a non-engagement position at which the engager is allowed to disengage from the engagement receiver when the operation portion is located at the unlocked position, and the loading portion includes a pusher urged in the direction opposite the first direction and configured to push the cover located at the cover position.

### BRIEF DESCRIPTION OF THE DRAWINGS

FIG. 1 is a perspective view of a first embodiment of a recording apparatus.

FIG. 2 is a diagrammatic cross-sectional view of the recording apparatus.

FIG. 3 is a perspective view of a first maintenance cover located at a non-cover position.

FIG. 4 is a cross-sectional view taken along the line F4-F4 in FIG. 3.

FIG. 5 is a perspective view of the first maintenance cover located at a cover position.

FIG. 6 is a plan view of an operation portion located at an unlocked position.

FIG. 7 is a plan view of the operation portion located at a locked position.

FIG. 8 is a cross-sectional view taken along the line F8-F8 in FIG. 5.

FIG. 9 is a partial perspective view of a second embodiment of the recording apparatus.

FIG. 10 is a perspective view of the first maintenance cover located at the cover position.

FIG. 11 is a plan view of the operation portion located at the unlocked position.

FIG. 12 is a plan view of the operation portion located at the locked position.

FIG. 13 is a partial plan view of the first maintenance cover in which an engager hits an engagement receiver.

FIG. 14 is an enlarged view of a portion F14 in FIG. 10.

FIG. 15 is a partial plan view of a third embodiment of the recording apparatus.

FIG. 16 is a perspective view of the first maintenance cover in the state in which the operation portion is located at the unlocked position.

FIG. 17 is a perspective view of the first maintenance cover in the state in which the operation portion is at the locked position.

FIG. 18 is a perspective view of the first maintenance cover of the recording apparatus according to a fourth embodiment.

FIG. 19 is a perspective view of the first maintenance cover in the state in which the operation portion is located at the unlocked position.

### DESCRIPTION OF EMBODIMENTS

### First embodiment

A first embodiment of a recording apparatus will be described below with reference to the drawings. The recording apparatus is, for example, an inkjet printer that ejects ink, which is an example of liquid, onto a medium such as a paper sheet, fabric, a vinyl sheet, a plastic part, and a metal part to perform recording.

In the drawings, a Z-axis represents the direction of gravity, and an X-axis and a Y-axis represent directions along a horizontal surface on the assumption that a recording apparatus 11 is placed on a horizontal surface. The X-axis, the Y-axis, and the Z-axis are orthogonal to each other. In the description below, a direction parallel to the X-axis is also referred to as a width direction X, a direction parallel to the Y-axis is also referred to as a depth direction Y, and a direction parallel to the Z-axis is also referred to as a vertical direction Z.

### Recording apparatus

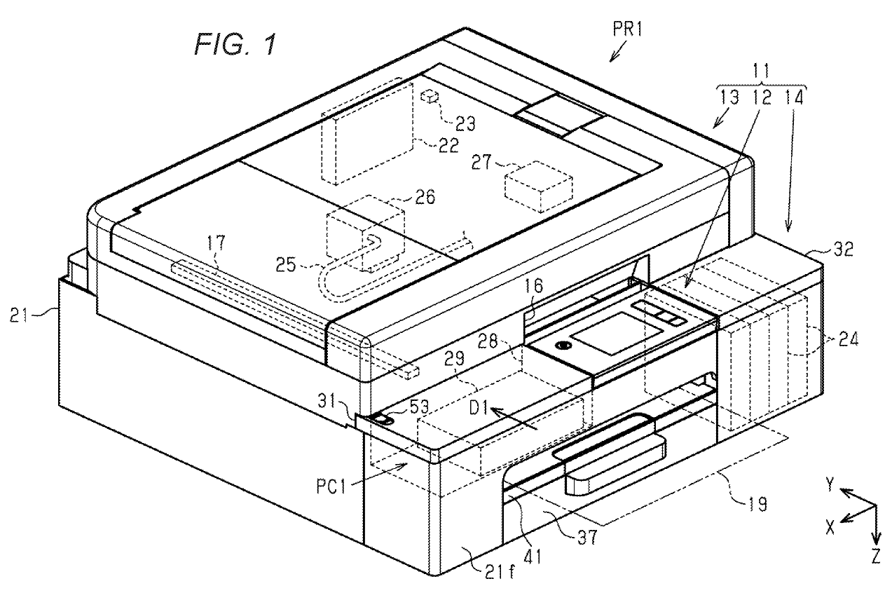

The recording apparatus 11 may include an operation panel 12, a reading unit 13, which is an example of a second cover, and a recording unit 14, as shown in FIG. 1. The reading unit 13 and the operation panel 12 may be provided above the recording unit 14.

### Operation panel

It is intended that a user operates the recording apparatus 11 via the operation panel 12. The operation panel 12 is operated by the user. The operation panel 12 may include a monitor, buttons, a touch panel, and the like.

### Reading unit

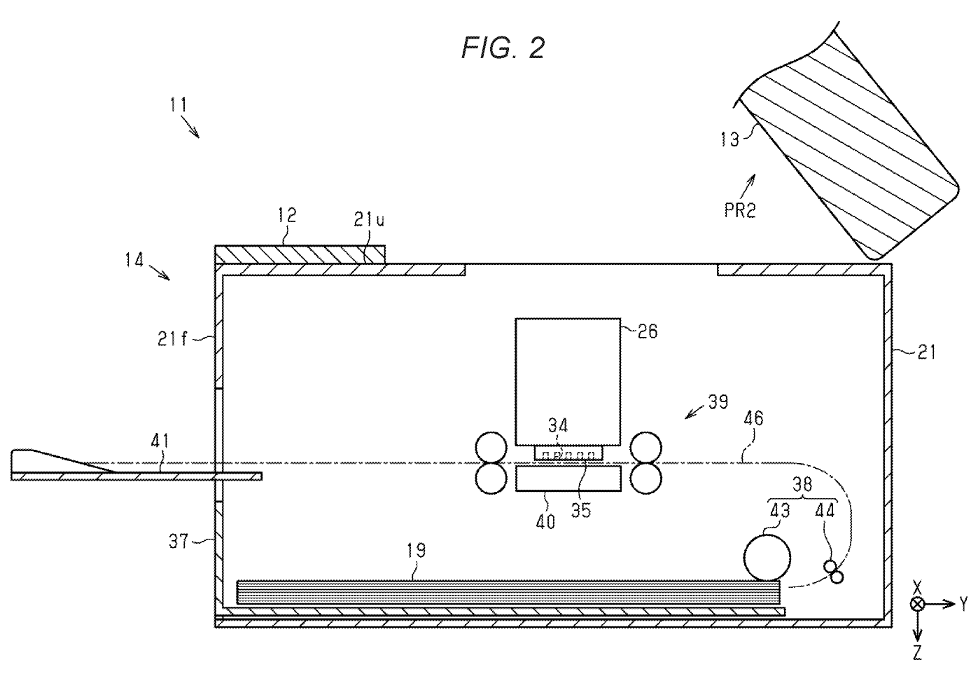

The reading unit 13 is configured to read an image of a document that is not shown. The reading unit 13 in the present embodiment is provided adjacent to the operation panel 12 at a position behind the operation panel 12 in the depth direction Y. The reading unit 13 may be rotatable around a hinge or a shaft that is not shown but is provided rearward in the depth direction Y. The reading unit 13 may be provided to be openable and closable with respect to the recording unit 14. The reading unit 13 may be so rotated that it is displaceable to a reading position PR1, which is an example of a second cover position shown FIG. 1, and a non-reading position PR2, which is an example of a second non-cover position shown in FIG. 2.

To read a document, for example, the user positions the reading unit 13 at the reading position PR1. To perform maintenance of the recording unit 14, for example, the user positions the reading unit 13 at the non-reading position PR2. The reading position PR1 is a position at which the interior of the apparatus is covered. The reading unit 13 located at the reading position PR1 extends along the recording unit 14 and covers a portion of the recording unit 14 from above. The non-reading position PR2 is a position at which the interior of the apparatus is not covered. The reading unit 13 located at the non-reading position PR2 uncovers the interior of the recording unit 14.

The reading unit 13 may include a handle 16 and a reader 17, as shown in FIG. 1.

The handle 16 may be a recess located at the front end of the reading unit 13. In the width direction X, the handle 16 may be approximately as large as the operation panel 12 or may be larger than the operation panel 12. The user can readily move the reading unit 13 located at the reading position PR1 to the non-reading position PR2 by putting his/her hand on the handle 16.

The reader 17 is configured to read an image of a document that is not shown. The reader 17 may be capable of reading a document when the reading unit 13 is located at the reading position PR1. The reader 17 may read a conveyed stationary document. The reader 17 may read a stationary document while moving. The reader 17 generates image data by reading a document.

### Recording unit

The recording unit 14 is configured to perform recording on a medium 19, as shown in FIG. 1. The recording unit 14 may include an enclosure 21, a controller 22, and a detector 23. The recording unit 14 may further include a liquid storing body 24, a supply channel 25, a recording portion 26, a maintenance portion 27, and a loading portion 28. A waste liquid storing body 29, which is an example of a loaded member, is loaded into the loading portion 28.

The recording unit 14 may include a first maintenance cover 31 and a second maintenance cover 32. The first maintenance cover 31 is an example of a cover and a first cover. The first maintenance cover 31 and the second maintenance cover 32 are so located that the two covers are separate from each other in the width direction X. The first maintenance cover 31 and the second maintenance cover 32 are provided adjacent to the operation panel 12 in a way that the two covers sandwich the operation panel 12 in the width direction X. In other words, the operation panel 12 is located between the first maintenance cover 31 and the second maintenance cover 32 in the width direction X.

The enclosure 21 houses various elements that constitute the recording unit 14. The enclosure 21 may have a front surface 21f and a first upper surface 21u, the latter of which is shown in FIG. 2. The front surface 21f is located forward in the depth direction Y. The first upper surface 21u is located upward in the vertical direction Z. The first upper surface 21u faces the operation panel 12.

The controller 22 harmoniously controls the operations of driving mechanisms in the recording unit 14 to control various operations performed by the recording unit 14. The controller 22 may harmoniously control the operations of driving mechanisms in the recording apparatus 11 to control various operations performed by the recording apparatus 11.

The controller 22 can be configured as a circuit including α: one or more processors that carry out various processes in accordance with a computer program, β: one or more dedicated hardware circuits that carry out at least some of the various processes, or γ: a combination of α and β. The hardware circuit is, for example, an application specific integrated circuit. The processor includes a CPU and a memory such as a RAM and a ROM, and the memory memorizes program codes or instructions configured to cause the CPU to carry out the processes. The memory, that is, a computer-readable medium includes any readable medium that can be accessed by a general-purpose or dedicated computer.

The detector 23 can detect whether the reading unit 13 is open or closed. The detector 23 may detect, for example, whether the reading unit 13 is located at the reading position PR1. The detector 23 is, for example, a contact sensor. The detector 23 is, for example, a photoelectric sensor including a light projector and a light receiver.

The liquid storing body 24 stores liquid to be supplied to the recording portion 26. The recording unit 14 may include one or more liquid storing bodies 24. The multiple liquid storing bodies 24 may be arranged in the width direction X. The multiple liquid storing bodies 24 may store different types of liquid. The different types of liquid are, for example, different types of ink having different colors. The liquid storing body 24 may be fixed to the recording unit 14. The liquid storing body 24 may be a refillable liquid storing body. The liquid storing body 24 may be a cartridge, a pack, or any other element that is configured separately from the recording unit 14 and is attachable to and detachable from the recording unit 14. That is, the recording unit 14 may not include the liquid storing body 24.

The second maintenance cover 32 is located above the one or more liquid storing bodies 24. The second maintenance cover 32 is openable and closable with respect to the enclosure 21. The second maintenance cover 32 may be opened or closed, for example, through rotation or sliding motion. The second maintenance cover 32 located at a closed position shown in FIG. 1 covers the liquid storing body 24. The second maintenance cover 32 located at an open position that is not shown exposes a portion of the liquid storing body 24. The second maintenance cover 32 located at the open position allows the liquid storing body 24 to be refilled with liquid or the liquid storing body 24 to be replaced with another.

The recording apparatus 11 may include one or more supply channels 25. The recording apparatus 11 may include supply channels 25 the number of which is equal to the number of the liquid storing bodies 24. The supply channel 25 may be configured with a deformable tube. The supply channel 25 can supply the recording portion 26 with liquid. The supply channel 25 has an upstream end coupled to the liquid storing body 24 and a downstream end coupled to the recording portion 26.

The recording portion 26 performs recording on the medium 19, as shown in FIG. 2. The recording portion 26 in the present embodiment is a liquid ejector capable of ejecting liquid. The recording portion 26 has a nozzle surface 35, at which one or more nozzles 34 open. The recording portion 26 ejects the liquid supplied from the liquid storing body 24 via the nozzle 34. The recording portion 26 performs recording by ejecting the liquid onto the medium 19. The recording portion 26 may be capable of making reciprocating movement in a scan direction. The scan direction may be a direction parallel to the X-axis.

The maintenance portion 27 performs maintenance of the recording portion 26, as shown in FIG. 1. Examples of the maintenance may include flushing, cleaning, and wiping. The maintenance portion 27 may forcibly discharge the liquid via the nozzle 34. The maintenance portion 27 suppresses deterioration of the liquid ejection performance of the nozzle 34 by causing the liquid having increased viscosity, foreign matter, air bubbles, or the like along with the original liquid to be discharged via the nozzle 34. The maintenance portion 27 collects the discharged liquid as waste liquid. The maintenance portion 27 sends the collected waste liquid to the waste liquid storing body 29.

The waste liquid storing body 29 can store the waste liquid discharged from the recording portion 26. The waste liquid storing body 29 stores the waste liquid collected by the maintenance portion 27. The waste liquid storing body 29 is attachable to and detachable from the recording apparatus 11.

The recording unit 14 may include a medium storing portion 37, a feeder 38, a conveyer 39, a support 40, and a discharge tray 41, as shown in FIG. 2.

The medium storing portion 37 can store multiple media 19 in a stacked manner.

The feeder 38 feeds the media 19 stored in the medium storing portion 37 one by one. The feeder 38 may include a feeding roller 43 and a separator 44. The feeding roller 43 rotates in a state in which the feeding roller 43 is in contact with the media 19 stored in the medium storing portion 37 to feed the media 19 to the separator 44. The separator 44 separates each of the fed multiple media 19 stacked on each other from the others.

The conveyer 39 conveys the medium 19 along a conveyance path 46 indicated by the one-dot chain line in FIG. 2. The conveyer 39 conveys the medium 19 fed by the feeder 38 to the discharge tray 41 located downstream in a conveyance direction. The conveyance direction is a direction along the conveyance path 46.

The support 40 supports the conveyed medium 19. The support 40 constitutes a portion of the conveyance path 46. The support 40 faces the recording portion 26 across the conveyance path 46.

The discharge tray 41 receives a recorded medium 19. The discharge tray 41 may be drawable. The discharge tray 41 may be capable of making reciprocating movement in the depth direction Y. The discharge tray 41 in the present embodiment is movable to a position shown in FIG. 1 where the discharge tray 41 is stored in the enclosure 21 and a position shown in FIG. 2 where the discharge tray 41 protrudes forward beyond the front surface 21f.

### Loading portion

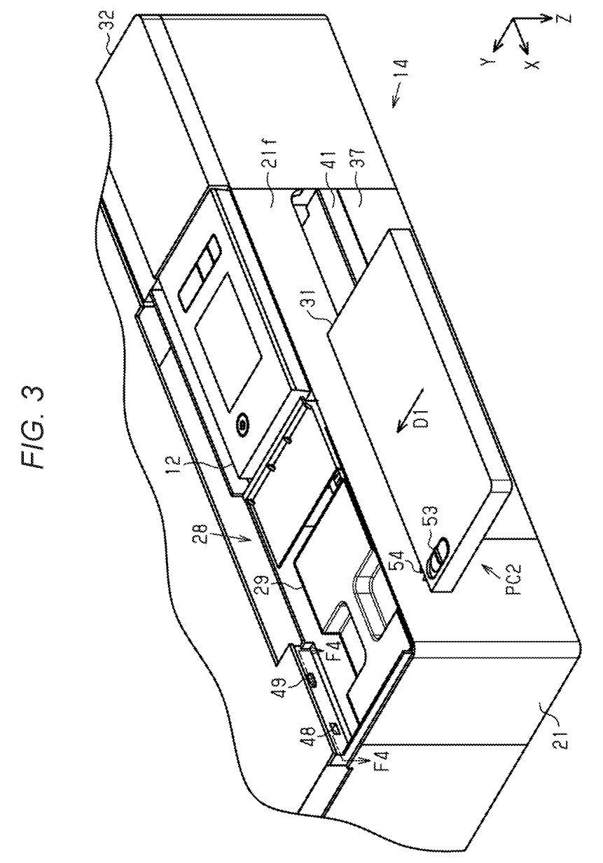

The loading portion 28 may be adjacent to the operation panel 12 in the width direction X, as shown in FIG. 3. The loading portion 28 has a loading space into which the waste liquid storing body 29 is loadable. The loading portion 28 may include an engagement receiver 48 and a pusher 49. The engagement receiver 48 in the present embodiment opens at a rear wall surface of the loading portion 28.

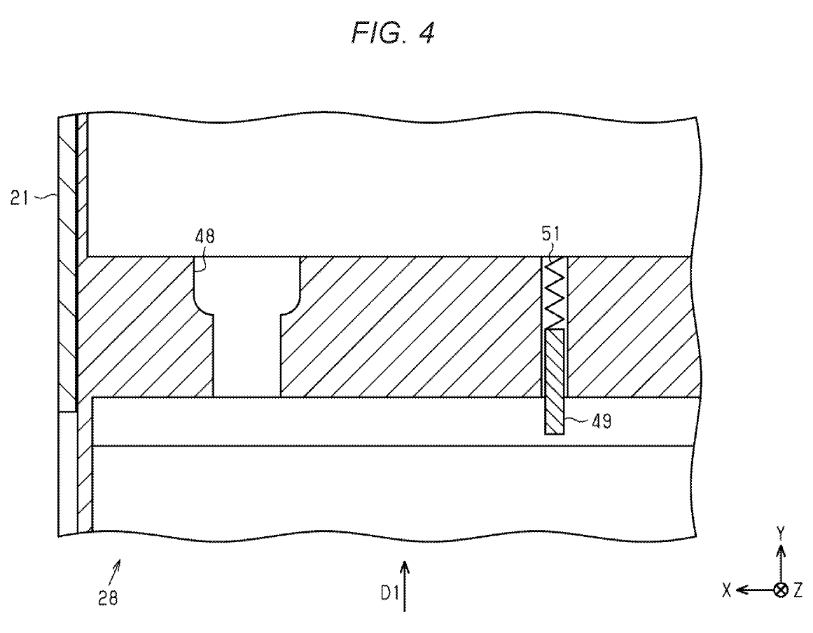

The loading portion 28 may include a first spring 51, as shown in FIG. 4. The first spring 51 urges the pusher 49 in the direction opposite a first direction D1. The term "urging" refers to pushing back or pulling back a target object against a force applied to the target object. The first direction D1 in the present embodiment is a direction parallel to the Y-axis. The first direction D1 in the present embodiment is the same as the depth direction Y and is a rearward direction. The first spring 51 pushes the pusher 49 in a forward direction, which is the direction opposite the first direction D1.

### First maintenance cover

The first maintenance cover 31 can be located at a non-cover position PC2, as shown in FIG. 3. The non-cover position PC2 is an example of a first non-cover position. The non-cover position PC2 is a position away from the enclosure 21. The non-cover position PC2 is a position where the loading portion 28 is not closed. The first maintenance cover 31 located at the non-cover position PC2 does not cover the loading space of the loading portion 28. The first maintenance cover 31 is displaced to the non-cover position PC2 to expose the loading portion 28. When the first maintenance cover 31 is at the non-cover position PC2, the waste liquid storing body 29 is attachable to and detachable from the loading portion 28.

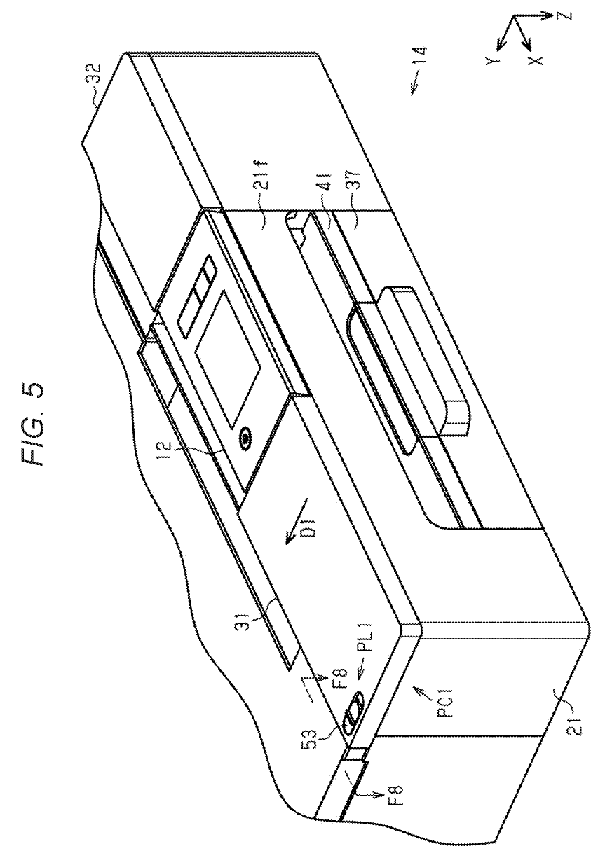

The first maintenance cover 31 is slidable in the first direction D1 and the direction opposite the first direction D1, as shown in FIGS. 3 and 5. The first maintenance cover 31 is caused to slide in the first direction D1 so that the first maintenance cover 31 is displaced from the non-cover position PC2 shown in FIG. 3 to a cover position PC1 shown in FIG. 5. The first maintenance cover 31 located at the cover position PC1 covers the loading space of the loading portion 28. The first maintenance cover 31 located at the cover position PC1 closes the loading portion 28 from above. The cover position PC1 is a position at which the loading portion 28 is closed. The first maintenance cover 31 is displaced from the cover position PC1 to the non-cover position PC2 when caused to slide in the direction opposite the first direction D1.

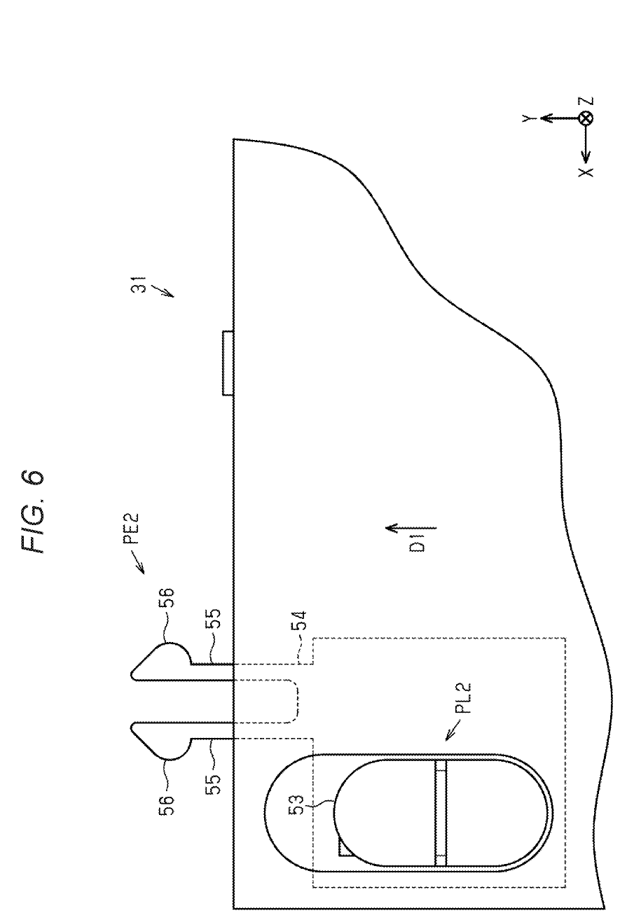

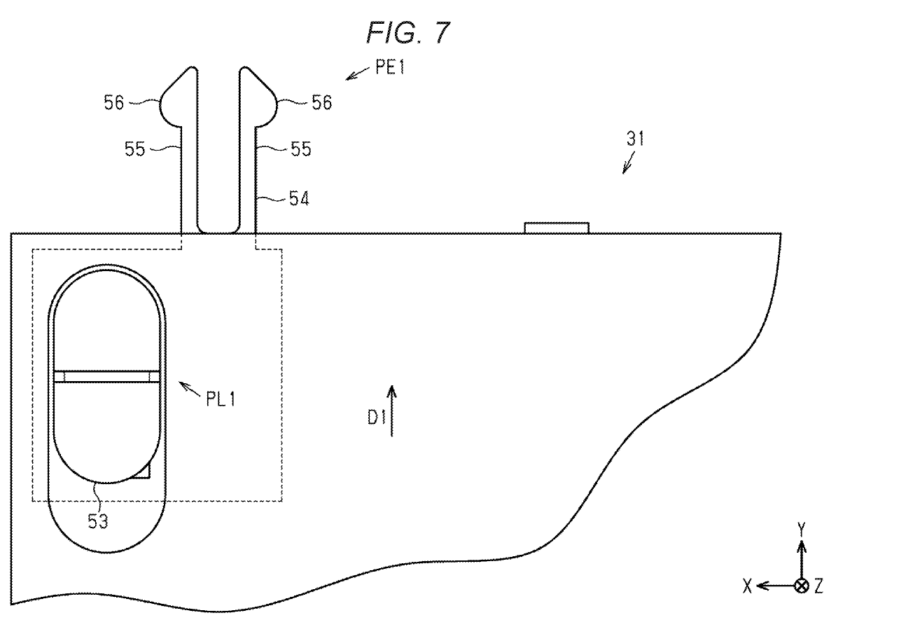

The first maintenance cover 31 includes an operation portion 53 and an engager 54, as shown in FIGS. 6 and 7.

The operation portion 53 is movable in the first direction D1 and the direction opposite the first direction D1 when externally operated. The operation portion 53 is slidable. The operation portion 53 is movable to a locked position PL1 shown in FIG. 7 and an unlocked position PL2 shown in FIG. 6.

The engager 54 may include arms 55 and claws 56. The arms 55 may extend in the first direction D1. The arms 55 may be deformable in a way that they bend. The claws 56 are provided at the tips of the arms 55 and overhang from the arms 55. The engager 54 in the present embodiment includes a pair of arms 55 and a pair of claws 56. The pair of claws 56 face outward away from each other.

The engager 54 is attached to the operation portion 53. The engager 54 moves in conjunction with the movement of the operation portion 53. The engager 54 is movable in the first direction D1 and the direction opposite the first direction D1. The engager 54 is slidable. The engager 54 moves in the first direction D1 and the direction opposite the first direction D1 to move to an engagement position PE1 shown in FIG. 7 and a non-engagement position PE2 shown in FIG. 6, respectively. The engagement position PE1 is a position where the engager 54 can engage with the engagement receiver 48. The non-engagement position PE2 is a position where the engager 54 cannot engage with the engagement receiver 48.

When the operation portion 53 is located at the unlocked position PL2, the engager 54 is located at the non-engagement position PE2, as shown in FIG. 6. The operation portion 53 located at the unlocked position PL2 moves to the locked position PL1 shown in FIG. 7 when moved in the first direction D1. When the operation portion 53 is moved in the first direction D1, the engager 54 moves to the engagement position PE1. When the operation portion 53 is located at the locked position PL1, the engager 54 is located at the engagement position PE1. When the operation portion 53 is moved in the direction opposite the first direction D1, the engager 54 moves to the non-engagement position PE2.

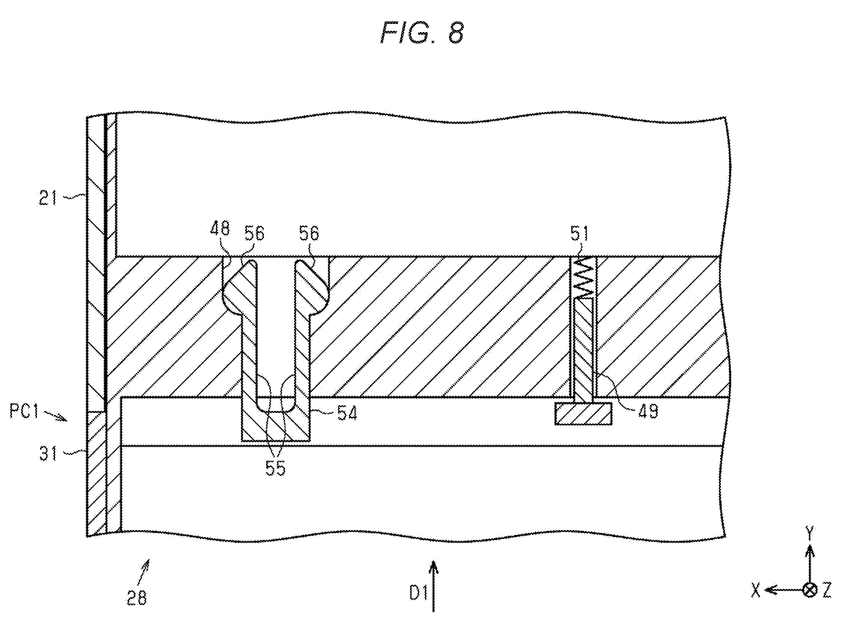

When the first maintenance cover 31 is located at the cover position PC1 and the operation portion 53 is located at the locked position PL1, the engager 54 engages with the engagement receiver 48, as shown in FIGS. 5 and 8.

The engager 54 makes the engagement in a way that the pair of claws 56 are caught by the engagement receiver 48, as shown in FIG. 8. The forward movement of the first maintenance cover 31 is restricted by the engagement of the engager 54 with the engagement receiver 48.

The first maintenance cover 31 may overlap with the reading unit 13 in the depth direction Y, as shown in FIG. 1. The rear end of the first maintenance cover 31 located at the cover position PC1 may be located behind the front end of the reading unit 13 located at the reading position PR1. At least a portion of the first maintenance cover 31 may enter the space below the reading unit 13. In other words, the reading unit 13 may be above the first maintenance cover 31. At least a portion of the first maintenance cover 31 located at the cover position PC1 may overlap with at least a portion of the reading unit 13 located at the reading position PR1. When the first maintenance cover 31 is located at the cover position PC1 and the reading unit 13 is located at the reading position PR1, at least a portion of the operation portion 53 may overlap with the reading unit 13. The reading unit 13 located at the reading position PR1 may hide at least a portion of the operation portion 53. When the reading unit 13 is at the reading position PR1, the operation of the operation portion 53 may be prohibited. When the reading unit 13 is located at the non-reading position PR2, the user is allowed to operate the operation portion 53. When the reading unit 13 is located at the non-reading position PR2, the first maintenance cover 31 can be attached to and detached from the recording apparatus 11.

### Effects of first embodiment

Effects of the present embodiment will be described.

The pusher 49 can press the first maintenance cover 31 located at the cover position PC1, as shown in FIG. 8. The pusher 49 pushes the first maintenance cover 31 forward. The force with which the pusher 49 pushes the first maintenance cover 31 is smaller than the force with which the engager 54 and the engagement receiver 48 restrict the movement of the first maintenance cover 31. Therefore, when the operation portion 53 is at the locked position PL1, the first maintenance cover 31 is held at the cover position PC1.

When the operation portion 53 is moved in the direction opposite the first direction D1, the engager 54 disengages from the engagement receiver 48. The first maintenance cover 31 is shifted from the cover position PC1 in the direction opposite the first direction D1 by the force with which the user moves the operation portion 53 in the direction opposite the first direction D1 and the force exerted by the pusher 49. The user can detach the first maintenance cover 31 by further displacing the first maintenance cover 31 in the direction opposite the first direction D1.

### Advantages of first embodiment

Advantages of the present embodiment will be described.

(1-1) When the operation portion 53 is moved in the direction opposite the first direction D1, the engager 54 moves to the non-engagement position PE2. That is, when the operation portion 53 is moved in the direction opposite the first direction D1, the engager 54 disengages from the engagement receiver 48, so that the first maintenance cover 31 becomes movable. The first maintenance cover 31 is displaced to the non-cover position PC2 when caused to slide in the direction opposite the first direction D1. The configuration in which the direction in which the user operates the operation portion 53 is the same as the direction in which the first maintenance cover 31 is caused to slide improves the user's operability of the operation portion 53 and the first maintenance cover 31.

(1-2) The engager 54 moves in the same direction as the operation portion 53. The force with which the user operates the operation portion 53 can therefore be used as it is to move the engager 54. Loss of the operation force can therefore be reduced.

(1-3) The reading unit 13 located at the reading position PR1 is located above the first maintenance cover 31 and therefore overlaps with the first maintenance cover 31. A concern that the first maintenance cover 31 is inadvertently detached can therefore be reduced.

(1-4) The reading unit 13 located at the reading position PR1 overlaps with the operation portion 53 of the first maintenance cover 31 located at the cover position PC1. A concern that the user inadvertently moves the operation portion 53 can therefore be reduced.

(1-5) The reading unit 13 includes the reader 17. The size of the apparatus can therefore be reduced as compared with a case where the reader 17 is separately provided.

(1-6) The first maintenance cover 31 covers the waste liquid storing body 29. The operability of the first maintenance cover 31 is improved as described in (1-1). A concern that it takes time for the user to detach the first maintenance cover 31 so that the user inadvertently touches the waste liquid storing body 29 can therefore be reduced.

### Second embodiment

A second embodiment of the recording apparatus will next be described with reference to the drawings. Note that the second embodiment differs from the first embodiment in terms of the configurations of the loading portion and the first maintenance cover. The other points in the second embodiment are substantially the same as those in the first embodiment, so that the same elements have the same reference characters, and no duplicated description thereof will be made.

### Loading portion

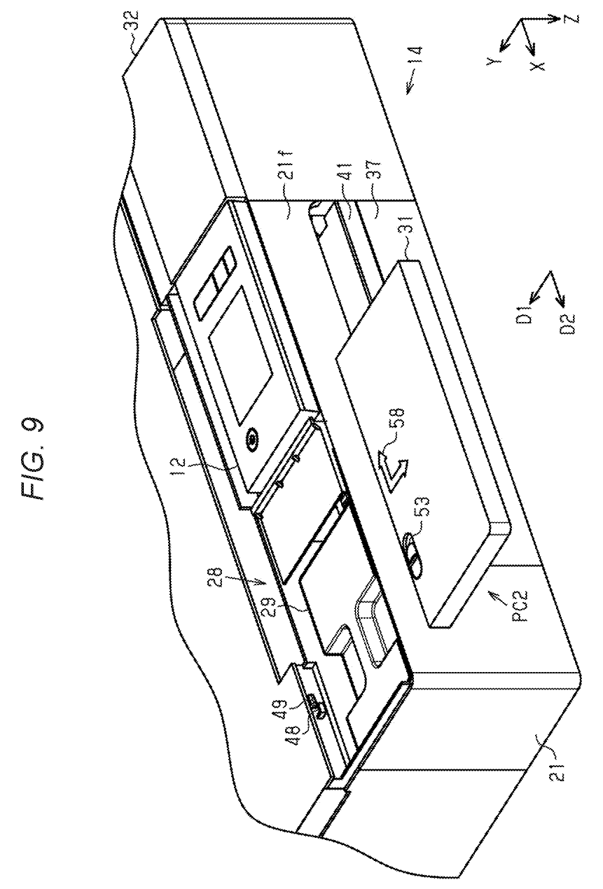

The loading portion 28 may include the engagement receiver 48 and the pusher 49, as shown in FIG. 9. The engagement receiver 48 in the present embodiment protrudes forward from the rear wall surface of the loading portion 28. The pusher 49 is urged in the direction opposite the first direction D1 and can push the first maintenance cover 31 located at the cover position PC1.

### First maintenance cover

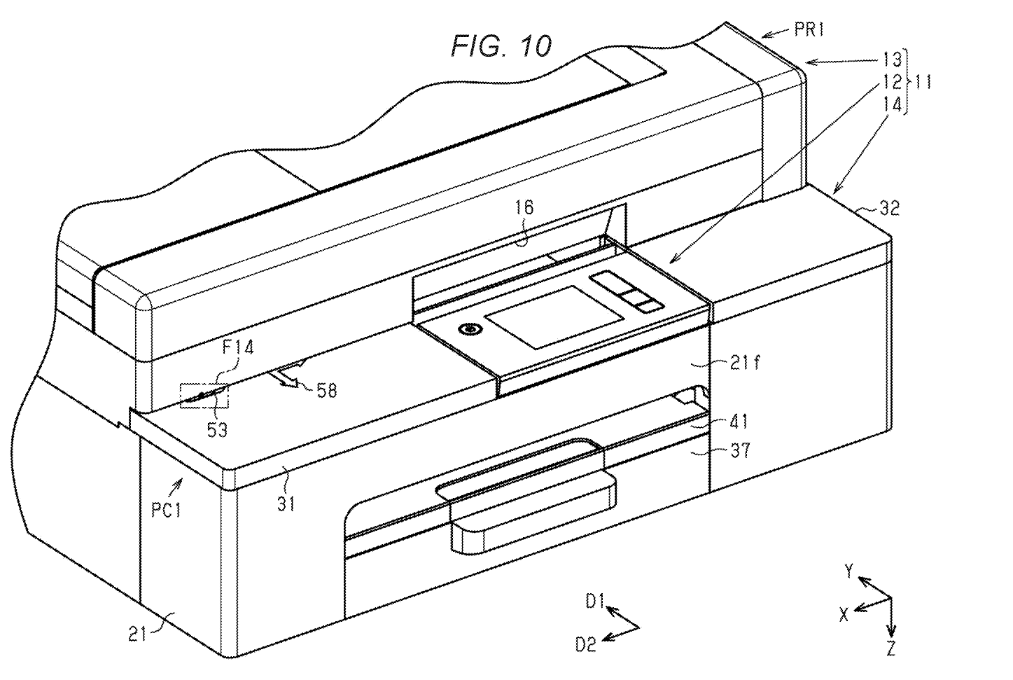

The first maintenance cover 31 is slidable in the first direction D1 and the direction opposite the first direction D1, as shown in FIGS. 9 and 10. The first maintenance cover 31 is displaced from the non-cover position PC2 shown in FIG. 9 to the cover position PC1 shown in FIG. 10 when caused to slide in the first direction D1. The first maintenance cover 31 is displaced from the cover position PC1 to the non-cover position PC2 when caused to slide in the direction opposite the first direction D1.

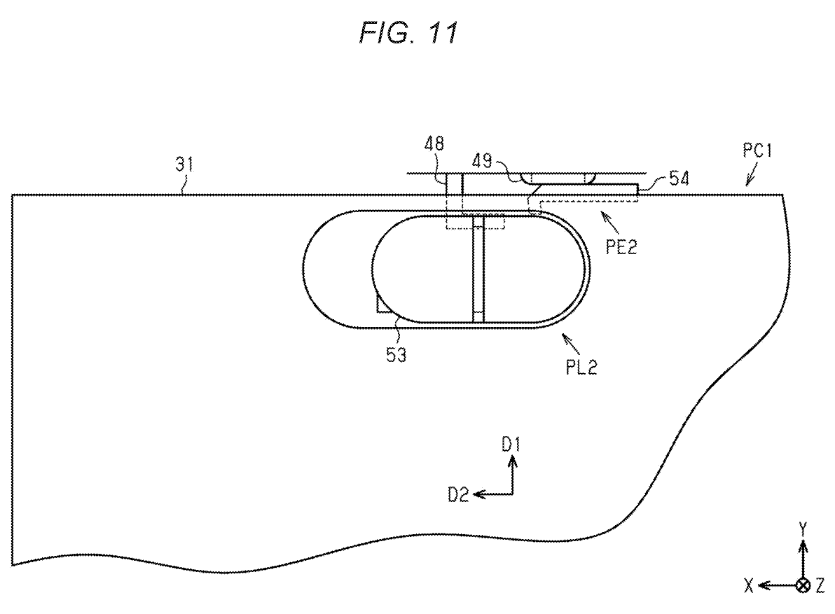

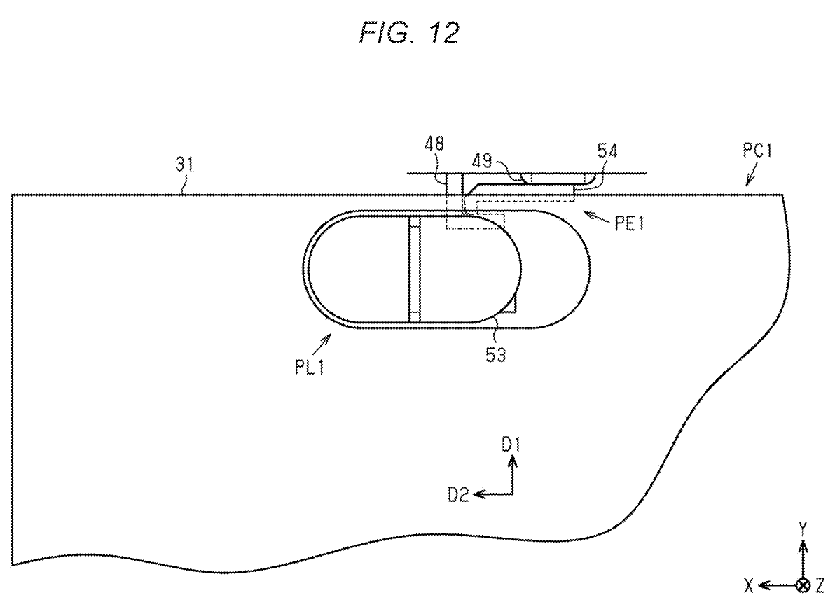

The first maintenance cover 31 may have a mark 58. The mark 58 may indicate operation directions in accordance with which the user detaches the first maintenance cover 31. The mark 58 may be an arrow indicating the direction toward the non-cover position PC2 in the state in which the first maintenance cover 31 is located at the cover position PC1. The mark 58 may be an arrow indicating the direction toward the unlocked position PL2 shown in FIG. 11 in the state in which the operation portion 53 is located at the locked position PL1 shown in FIG. 12.

The operation portion 53 is movable in a second direction D2 and the direction opposite the second direction D2 when externally operated, as shown in FIGS. 11 and 12. The operation portion 53 is slidable. The second direction D2 is a direction different from the first direction D1. The second direction D2 in the present embodiment is a direction parallel to the X-axis. The second direction D2 is the same as the width direction X. The operation portion 53 is movable to the locked position PL1 shown in FIG. 12 and the unlocked position PL2 shown in FIG. 11. The operation portion 53 moves to the locked position PL1 when moved in the second direction D2. The operation portion 53 moves to the unlocked position PL2 when moved in the direction opposite the second direction D2.

The engager 54 is attached to the operation portion 53. The engager 54 moves in conjunction with the movement of the operation portion 53. The engager 54 is movable in the second direction D2 and the direction opposite the second direction D2. The engager 54 is slidable. The engager 54 moves to the engagement position PE1 shown in FIG. 12 and the non-engagement position PE2 shown in FIG. 11 when moved in the second direction D2 and the direction opposite the second direction D2, respectively.

When the operation portion 53 is located at the unlocked position PL2, the engager 54 is located at the non-engagement position PE2, as shown in FIG. 11. The operation portion 53 located at the unlocked position PL2 moves to the locked position PL1 shown in FIG. 12 when moved in the second direction D2. When the operation portion 53 is moved in the second direction D2, the engager 54 moves to the engagement position PE1. When the operation portion 53 is located at the locked position PL1, the engager 54 is located at the engagement position PE1. When the operation portion 53 is moved in the direction opposite the second direction D2, the engager 54 moves to the non-engagement position PE2.

When the first maintenance cover 31 is located at the cover position PC1 and the operation portion 53 is located at the locked position PL1, the engager 54 engages with the engagement receiver 48, as shown in FIG. 12. At this point in time, the engager 54 is located behind the engagement receiver 48. The forward movement of the first maintenance cover 31 is therefore restricted.

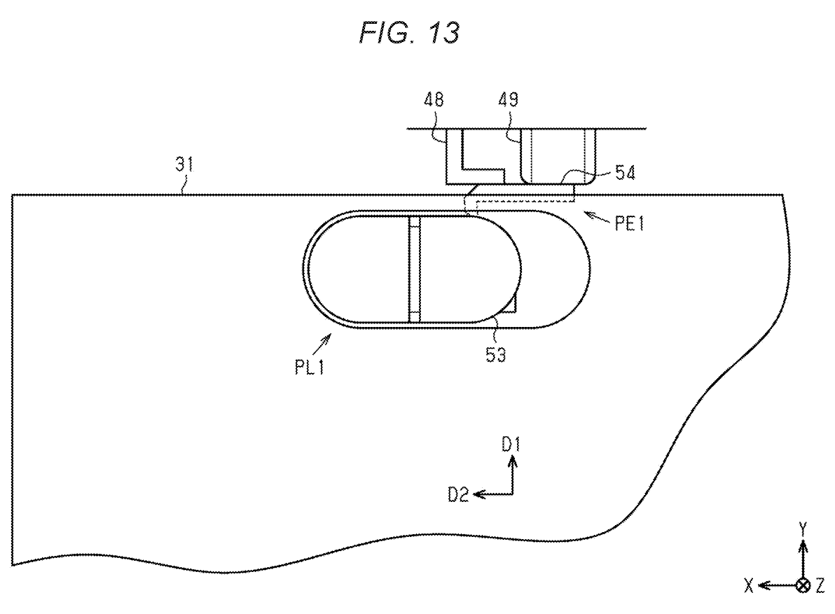

The first maintenance cover 31 moving from the non-cover position PC2 in the first direction D1 in the state in which the engager 54 is located at the engagement position PE1 interferes with the loading portion 28 before moving to the cover position PC1, as shown in FIG. 13. Specifically, in the first maintenance cover 31, the engager 54 located at the engagement position PE1 hits the engagement receiver 48. The movement of the first maintenance cover 31 in the first direction D1 is therefore restricted before the first maintenance cover 31 reaches the cover position PC1.

The reading unit 13 may be above the first maintenance cover 31, as shown in FIG. 10. At least a portion of the first maintenance cover 31 located at the cover position PC1 may overlap with at least a portion of the reading unit 13 located at the reading position PR1. When the first maintenance cover 31 is located at the cover position PC1 and the reading unit 13 is located at the reading position PR1, at least a portion of the operation portion 53 may overlap with the reading unit 13.

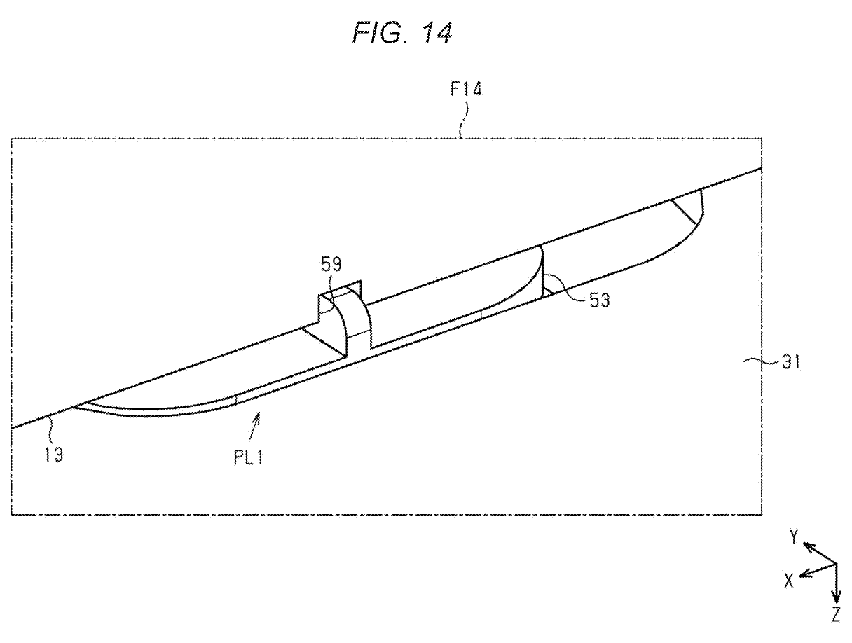

The reading unit 13 may have a clearance groove 59, as shown in FIG. 14. When the first maintenance cover 31 is located at the cover position PC1 and the reading unit 13 is located at the reading position PR1, a portion of the operation portion 53 located at the locked position PL1 is located in the clearance groove 59. However, when the operation portion 53 is not located at the locked position PL1 but is located, for example, at the unlocked position PL2, the operation portion 53 is out of the clearance groove 59 and interferes with the reading unit 13. Therefore, in the state in which the first maintenance cover 31 is located at the cover position PC1 and the operation portion 53 is located at the unlocked position PL2, the reading unit 13 moving from the non-reading position PR2 to the reading position PR1 interferes with the operation portion 53 before moving to the reading position PR1. When the detector 23 detects that the reading unit 13 is not located at the reading position PR1, the controller 22 may cause, for example, the operation panel 12 to notify that the first maintenance cover 31 is not fixed.

### Effects of second embodiment

Effects of the present embodiment will be described.

The pusher 49 pushes the first maintenance cover 31 located at the cover position PC1 in the direction opposite the first direction D1 when urged by the first spring 51, as shown in FIG. 12. The pusher 49 may push the engager 54 forward.

When the operation portion 53 located at the locked position PL1 is moved in the direction opposite the second direction D2, the engager 54 disengages from the engagement receiver 48. The first maintenance cover 31 is shifted from the cover position PC1 in the direction opposite the first direction D1 by the force exerted by the pusher 49. The user can detach the first maintenance cover 31 by further displacing the first maintenance cover 31 in the direction opposite the first direction D1.

### Advantages of second embodiment

Advantages of the present embodiment will be described.

(2-1) The pusher 49 pushes the first maintenance cover 31 located at the cover position PC1 toward the non-cover position PC2. Therefore, when the engager 54 disengages from the engagement receiver 48, the first maintenance cover 31 moves in the direction opposite the first direction D1. The direction in which the first maintenance cover 31 is detached is therefore readily known, so that the user's operability of the first maintenance cover 31 can be improved.

(2-2) The configuration in which the pusher 49 pushes the first maintenance cover 31 allows the user to readily know the direction in which the first maintenance cover 31 is detached. Therefore, even when the direction in which the operation portion 53 is moved differs from the direction in which the first maintenance cover 31 is caused to slide, a concern that the user is confused at how to detach the first maintenance cover 31 can be reduced. The operation portion 53 can therefore be configured with increased flexibility.

(2-3) In the state in which the engager 54 is located at the engagement position PE1, the engager 54 interferes with the loading portion 28. The first maintenance cover 31 cannot therefore be displaced to the cover position PC1. A concern that the cover is erroneously attached can therefore be reduced.

(2-4) The detector 23 detects whether the reading unit 13 is open or closed. A concern that the reading unit 13 not located at the reading position PR1 is used can therefore be reduced.

### Third embodiment

A third embodiment of the recording apparatus will next be described with reference to the drawings. Note that the third embodiment differs from the first embodiment in terms of the configurations of the loading portion and the first maintenance cover. The other points in the third embodiment are substantially the same as those in the first embodiment, so that the same elements have the same reference characters, and no duplicated description thereof will be made.

### Loading portion

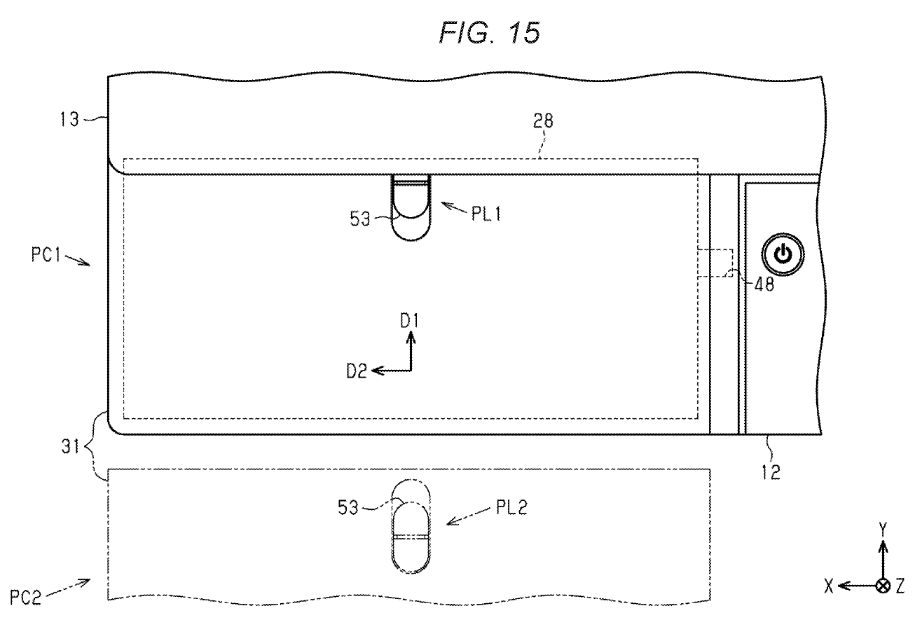

The loading portion 28 includes the engagement receiver 48, as shown in FIG. 15. The engagement receiver 48 in the present embodiment opens at a side wall surface of the loading portion 28. The engagement receiver 48 may be located between the first maintenance cover 31 located at the cover position PC1 and the operation panel 12 in the width direction X.

### First maintenance cover

The first maintenance cover 31 is slidable in the first direction D1 and the direction opposite the first direction D1, as shown in FIG. 15. The first maintenance cover 31 is displaced from the non-cover position PC2 indicated by the two-dot chain line in FIG. 15 to the cover position PC1 when caused to slide in the first direction D1. The first maintenance cover 31 is displaced from the cover position PC1 to the non-cover position PC2 when caused to slide in the direction opposite the first direction D1.

The first maintenance cover 31 includes the operation portion 53. The operation portion 53 is movable in the first direction D1 and the direction opposite the first direction D1 when externally operated. The operation portion 53 is slidable. The operation portion 53 is movable to the locked position PL1 and the unlocked position PL2.

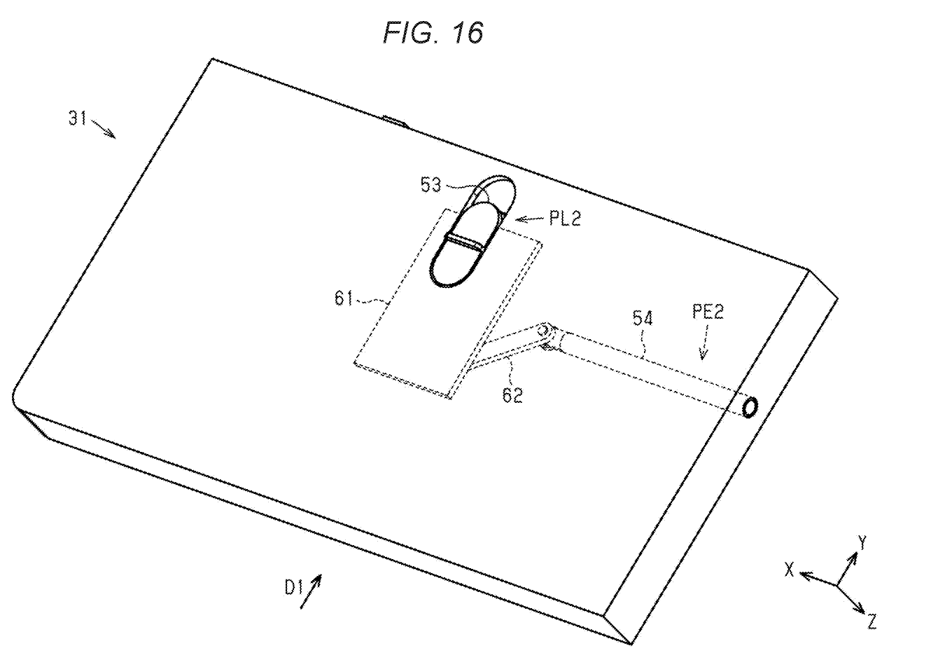

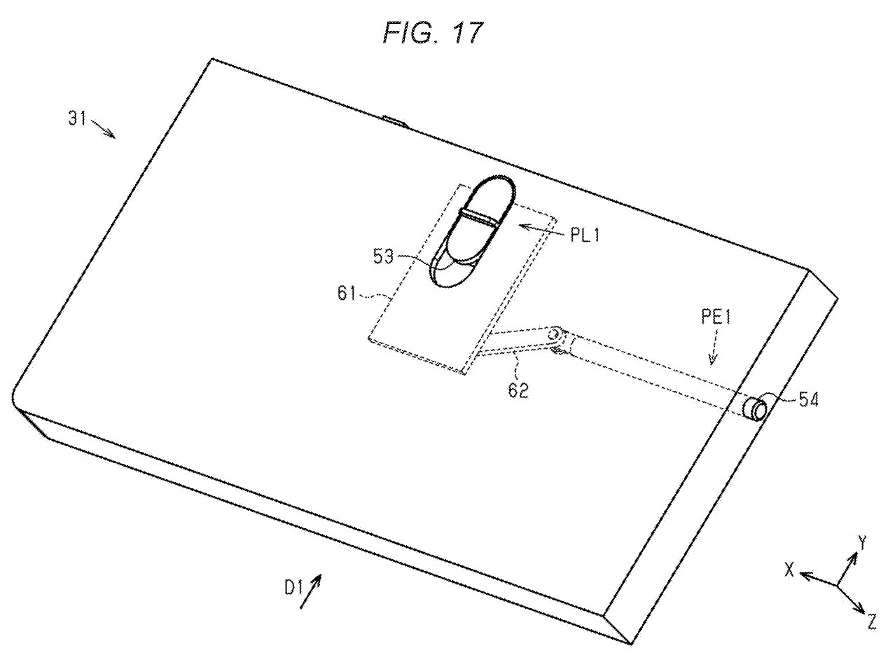

The first maintenance cover 31 may include the engager 54, a first link 61, and a second link 62, as shown in FIGS. 16 and 17.

The first link 61 is coupled to the operation portion 53 and the second link 62. The second link 62 couples the first link 61 and the engager 54 to each other. The engager 54 moves in conjunction with the movement of the operation portion 53. The engager 54 is movable in the second direction D2 and the direction opposite the second direction D2. The engager 54 is slidable. The engager 54 moves to the engagement position PE1 shown in FIG. 17 and the non-engagement position PE2 shown in FIG. 16 when moved in the second direction D2 and the direction opposite the second direction D2, respectively.

When the operation portion 53 is located at the unlocked position PL2, the engager 54 is located at the non-engagement position PE2. The operation portion 53 located at the unlocked position PL2 moves to the locked position PL1 when moved in the first direction D1. When the operation portion 53 is moved in the first direction D1, the engager 54 moves to the engagement position PE1. When the operation portion 53 is located at the locked position PL1, the engager 54 is located at the engagement position PE1. When the operation portion 53 is moved in the direction opposite the first direction D1, the engager 54 moves to the non-engagement position PE2.

When the first maintenance cover 31 is located at the cover position PC1 and the operation portion 53 is located at the locked position PL1, the engager 54 engages with the engagement receiver 48, as shown in FIG. 15. The forward movement of the first maintenance cover 31 is restricted by the engagement of the engager 54 with the engagement receiver 48.

The engager 54 located at the engagement position PE1 protrudes beyond the first maintenance cover 31, as shown in FIG. 17. The first maintenance cover 31 moving in the first direction D1 from the non-cover position PC2 in the state in which the engager 54 is located at the engagement position PE1 interferes with the loading portion 28 before moving to the cover position PC1. The first maintenance cover 31 may interfere with a member through which the loading portion 28 opens. The movement of the first maintenance cover 31 in the first direction D1 is restricted before the first maintenance cover 31 reaches the cover position PC1.

### Effects of third embodiment

Effects of the present embodiment will be described.

When the operation portion 53 is moved in the direction opposite the first direction D1, the engager 54 disengages from the engagement receiver 48, as shown in FIG. 15. The user can detach the first maintenance cover 31 by displacing the first maintenance cover 31 in the direction opposite the first direction D1.

### Advantages of third embodiment

Advantages of the present embodiment will be described.

(3-1) The engager 54 moves in a direction different from the direction in which the first maintenance cover 31 is caused to slide. Therefore, even when a force acts on the first maintenance cover 31 in the state in which the engager 54 engages with the engagement receiver 48, the first maintenance cover 31 is unlikely to move.

### Fourth embodiment

A fourth embodiment of the recording apparatus will next be described with reference to the drawings. Note that the fourth embodiment differs from the first embodiment in terms of the configuration of the first maintenance cover. The other points in the fourth embodiment are substantially the same as those in the first embodiment, so that the same elements have the same reference characters, and no duplicated description thereof will be made.

### First maintenance cover

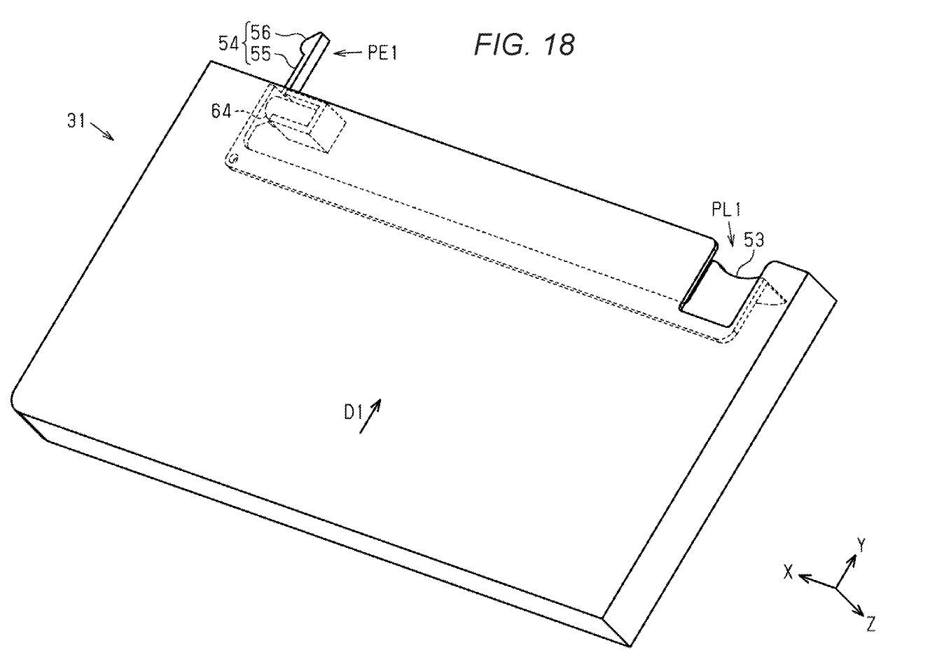

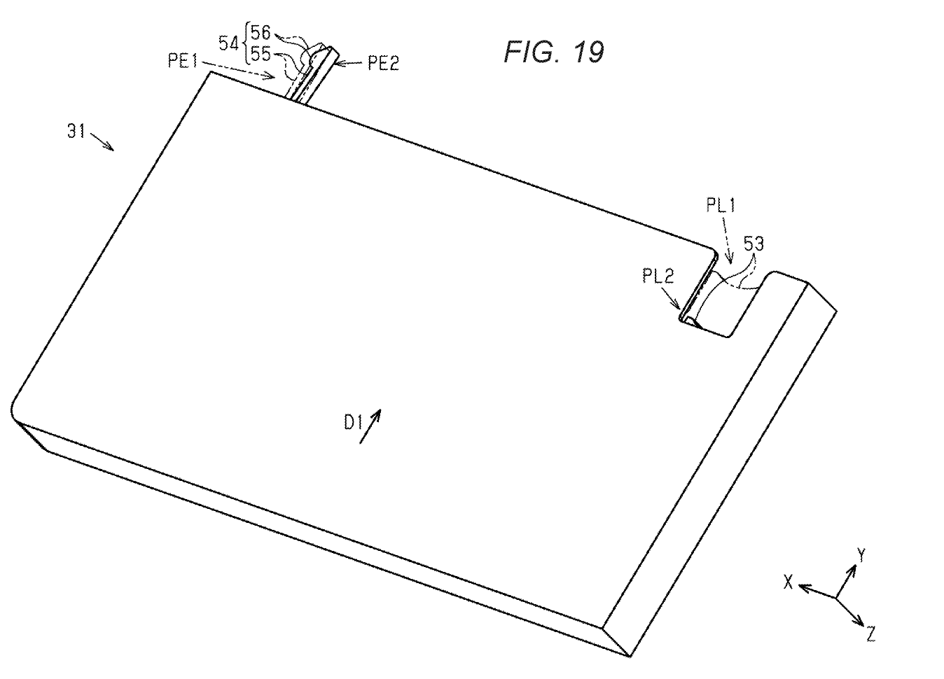

The first maintenance cover 31 may include the operation portion 53, the engager 54, and a second spring 64, as shown in FIGS. 18 and 19. In the width direction X, the operation portion 53 may be located at one end of the first maintenance cover 31, and the engager 54 may be located at the other end thereof. The operation portion 53 is movable in the first direction D1 and the direction opposite the first direction D1 when externally operated. The operation portion 53 is movable to the locked position PL1 and the unlocked position PL2.

The engager 54 is integrated with the operation portion 53. The engager 54 moves in conjunction with the movement of the operation portion 53. The operation portion 53 and the engager 54 can make pivotal motion around an axis. The pivotal motion refers to rotation made around an axis by an angle of rotation smaller than 360 degrees. The engager 54 moves to the engagement position PE1 and the non-engagement position PE2 when caused to make pivotal motion. The second spring 64 pushes the engager 54 located at the non-engagement position PE2 toward the engagement position PE1.

When the operation portion 53 is located at the unlocked position PL2, the engager 54 is located at the non-engagement position PE2, as shown in FIG. 19. The operation portion 53 located at the unlocked position PL2 moves to the locked position PL1 when moved in the first direction D1 by the urging force exerted by the second spring 64. When the operation portion 53 is moved in the first direction D1, the engager 54 moves to the engagement position PE1. When the operation portion 53 is located at the locked position PL1, the engager 54 is located at the engagement position PE1. When the operation portion 53 is moved in the direction opposite the first direction D1, the engager 54 moves to the non-engagement position PE2.

### Effects of fourth embodiment

Effects of the present embodiment will be described.

When the operation portion 53 is moved in the direction opposite the first direction D1, the engager 54 disengages from the engagement receiver 48, as shown in FIG. 19. The user can detach the first maintenance cover 31 by displacing the first maintenance cover 31 in the direction opposite the first direction D1.

### Advantages of fourth embodiment

Advantages of the present embodiment will be described.

(4-1) The engager 54 makes pivotal motion. The engager 54 can therefore be moved with a small force as compared, for example, with the case where the engager 54 is caused to slide.

### Variations

The embodiments described above can be changed and implemented as described below. The embodiments described above and the variations described below can be implemented in combination with each other as long as no technical inconsistencies are involved.

When the detector 23 detects that the reading unit 13 is not located at the reading position PR1, the controller 22 may prohibit recording.

At least a portion of the second maintenance cover 32 located at the closed position may overlap with the reading unit 13 located at the reading position PR1. When the reading unit 13 is located at the reading position PR1, displacement of the second maintenance cover 32 from the closed position to the open position may be restricted. When the reading unit 13 is located at the non-reading position PR2, displacement of the second maintenance cover 32 from the closed position to the open position may be allowed.

The recording apparatus 11 may include a second cover separately from the reading unit 13. The second cover may not include the reader 17. For example, the recording apparatus 11 may include a second cover that is opened and closed when a medium 19 jammed during the conveyance is removed. The second cover may overlap with at least a portion of the first maintenance cover 31 or at least a portion of the operation portion 53. The second cover may be located forward of the first maintenance cover 31 in the depth direction Y.

The detector 23 may detect the position of the operation portion 53. The detector 23 may detect that the engager 54 has engaged with the engagement receiver 48.

When the first maintenance cover 31 is located at the cover position PC1, and the reading unit 13 is located at the reading position PR1, the operation portion 53 may be located at a position where the operation portion 53 does not overlap with the reading unit 13.

The first maintenance cover 31 located at the cover position PC1 may not overlap with the reading unit 13 located at the reading position PR1. The first maintenance cover 31 may be displaceable to the cover position PC1 and the non-cover position PC2 while the reading unit 13 is located at the reading position PR1.

In the third and fourth embodiments, the pusher 49 may push the first maintenance cover 31 in the direction opposite the first direction D1.

In the first embodiment, the loading portion 28 may not include the pusher 49.

The recording apparatus 11 may include multiple loading portions 28.

The recording apparatus 11 may include a loading portion 28 into which the liquid storing body 24 can be loaded. The liquid storing body 24 may be an example of the loaded member. The second maintenance cover 32 may be an example of the cover and the first cover. The second maintenance cover 32 may include the operation portion 53 and the engager 54.

The medium storing portion 37 may be an example of the loaded member. The recording apparatus 11 may include a cover that covers the medium storing portion 37.

Multiple loaded members may be loaded into one loading portion 28. For example, the liquid storing body 24 and the waste liquid storing body 29 may be loadable into the loading portion 28.

A toner cartridge, which is an example of the loaded member, may be loadable into the loading portion 28. The toner cartridge may store toner used to perform recording.

A toner box, which is an example of the loaded member, may be loadable into the loading portion 28. The toner box may store collected toner.

The recording apparatus 11 is not limited to an inkjet printer, and may be a laser printer, a thermal printer, a dot impact printer, a digital printing machine, or the like.

The recording apparatus may be a liquid spraying apparatus that sprays or ejects liquid other than ink to perform recording. The state of the liquid ejected in the form of a very small amount of droplets from the liquid spraying apparatus includes a particle state, a tear-drop state, and a thread state having a trailing end. The liquid mentioned herein may be any material that can be sprayed from the liquid spraying apparatus. For example, the liquid only needs to be a substance in a liquid phase, and includes high- or low-viscosity liquid, sol, gel water, other inorganic solvents, organic solvents, solutions, and fluid substances such as liquid resin, liquid metal, and metal melt. The liquid includes not only liquid as one state of a substance but also functional material particles made of solid matter such as pigment or metal particles and dissolved, dispersed, or mixed in a solvent. Representative examples of the liquid may include the ink described in the aforementioned embodiments, a liquid crystal, and the like. It is assumed that the term "ink" includes various types of liquid composition such as typical water-based ink, oil-based ink, gel ink, and hot melt ink. Specific examples of the liquid spraying apparatus include an apparatus that sprays liquid containing a material in a dispersed or dissolved form, the material being, for example, an electrode material or a coloring material used, for example, to manufacture a liquid crystal display, an electroluminescence display, a surface-emitting display, and a color filter. The liquid spraying apparatus may be an apparatus that sprays a bioorganic substance used to manufacture a biochip, an apparatus that is used as a precision pipette and sprays liquid serving as a sample, a textile printing apparatus, a micro dispenser, or the like. The liquid spraying apparatus can be an apparatus that sprays lubricating oil to a precision machine such as a timepiece and a camera in a pinpoint manner, or an apparatus that sprays transparent resin liquid such as ultraviolet curable resin onto a substrate in order to form a minute hemispherical lens, an optical lens, or the like used for an optical communication element or the like. The liquid spraying apparatus may be an apparatus that sprays an acid or alkali etching solution or the like in order to etch a substrate or the like.

### Definitions

The expression "at least one" used in the present specification means "one or more" of desired candidates. For example, the expression "at least one" used in the present specification means "only one candidate" or "both of two candidates" when the number of candidates is two. As another example, the expression "at least one" used in the present specification means "only one candidate”, "the combination of any two candidates”, or "the combination of any three or more candidates" when the number of candidates is three or more.

### Additional Remarks

Technical ideas grasped from the embodiments and variations described above, and the effects and advantages thereof will be described below.

[1] A recording apparatus includes a recording portion configured to perform recording on a medium; a loading portion having a loading space in which a loaded member is loadable; and a cover displaced from a non-cover position at which the cover does not cover the loading space to a cover position at which the cover covers the loading space when caused to slide in a first direction, and displaced from the cover position to the non-cover position when caused to slide in a direction opposite the first direction, the cover includes an operation portion that is movable in the first direction and the direction opposite the first direction when externally operated, and an engager engageable with an engagement receiver provided in the loading portion, and the engager moves to an engagement position at which the engager is engageable with the engagement receiver when the operation portion is moved in the first direction, and moves to a non-engagement position at which the engager is not engageable with the engagement receiver when the operation portion is moved from the engagement position in the direction opposite the first direction.

According to the configuration described above, when the operation portion is moved in the direction opposite the first direction, the engager moves to the non-engagement position. That is, when the operation portion is moved in the direction opposite the first direction, the engager disengages from the engagement receiver, so that the cover becomes movable. The cover is displaced to the non-covering position when caused to slide in the direction opposite the first direction. The configuration in which the direction in which the user operates the operation portion is the same as the direction in which the cover is caused to slide improves the user's operability of the operation portion and the cover.

[2] A recording apparatus includes a recording portion configured to perform recording on a medium; a loading portion having a loading space into which a loaded member is loadable; and a cover displaced from a non-cover position at which the cover does not cover the loading space to a cover position at which the cover covers the loading space when caused to slide in a first direction, and displaced from the cover position to the non-cover position when caused to slide in a direction opposite the first direction, the cover includes an operation portion movable to a locked position and an unlocked position when externally operated, and an engager engageable with an engagement receiver provided in the loading portion, the engager is located at an engagement position at which the engager is engageable with the engagement receiver when the operation portion is located at the locked position, and is located at a non-engagement position at which the engager is allowed to disengage from the engagement receiver when the operation portion is located at the unlocked position, and the loading portion includes a pusher urged in the direction opposite the first direction and configured to push the cover located at the cover position.

According to the configuration described above, the pusher pushes the cover located at the cover position toward the non-cover position. Therefore, when the engager disengages from the engagement receiver, the cover moves in the direction opposite the first direction. The direction in which the cover is detached is therefore readily known, so that the user's operability of the cover can be improved.

[3] In the recording apparatus according to [2] described above, the operation portion may move to the locked position when moved in a second direction different from the first direction, and to the unlocked position when moved in a direction opposite the second direction.

The configuration described above, in which the pusher pushes the cover, allows the user to readily know the direction in which the cover is detached. Therefore, even when the direction in which the operation portion is moved differs from the direction in which the cover is caused to slide, a concern that the user is confused at how to detach the cover can be reduced. The operation portion can therefore be configured with increased flexibility.

[4] In the recording apparatus according to [1] or [2] described above, the engager may move to the engagement position and the non-engagement position when moved in the first direction and the direction opposite the first direction, respectively.

According to the configuration described above, the engager moves in the same direction as the operation portion. The force with which the user operates the operation portion can therefore be used as it is to move the engager. Loss of the operation force can therefore be reduced.

[5] In the recording apparatus according to [1] or [2] described above, the engager may move to the engagement position and the non-engagement position when moved in a second direction different from the first direction and a direction opposite the second direction, respectively.

According to the configuration described above, the engager moves in a direction different from the direction in which the cover is caused to slide. Therefore, even when a force acts on the cover in the state in which the engager engages with the engagement receiver, the cover is unlikely to move.

[6] In the recording apparatus according to [1] or [2] described above, the engager may move to the engagement position and the non-engagement position when caused to pivot.

According to the configuration described above, the engager pivots. The engager can therefore be moved with a small force as compared, for example, with a case where the engager is caused to slide.

[7] In the recording apparatus according to [1] or [2] described above, the cover moving from the non-cover position in the first direction in a state in which the engager is located at the engagement position may interfere with the loading portion before moving to the cover position.

According to the configuration described above, in the state in which the engager is located at the engagement position, the engager interferes with the loading portion. The cover cannot therefore be displaced to the cover position. A concern that the cover is erroneously attached can therefore be reduced.

[8] In the recording apparatus according to any one of [1] to [7] described above, the cover is called a first cover, the cover position is called a first cover position, and the non-cover position is called a first non-cover position, the recording apparatus may further include a second cover, the second cover may be displaceable to a second cover position at which the second cover covers an interior of the apparatus, and a second non-cover position at which the second cover does not cover the interior of the apparatus, at least a portion of the first cover located at the first cover position may overlap with at least a portion of the second cover located at the second cover position, and the second cover may be located above the first cover.

According to the configuration described above, the second cover located at the second cover position is located above the first cover and overlaps with the first cover. A concern that the first cover is inadvertently detached can therefore be reduced.

[9] In the recording apparatus according to [8] described above, when the first cover is located at the first cover position, and the second cover is located at the second cover position, at least a portion of the operation portion may overlap with the second cover.

According to the configuration described above, the second cover located at the second cover position overlaps with the operation portion of the first cover located at the first cover position. A concern that the user inadvertently moves the operation portion can therefore be reduced.

In the recording apparatus according to [8] or [9] described above, in a state in which the first cover is located at the first cover position, and the operation portion is located at the unlocked position, the second cover moving from the second non-cover position to the second cover position may interfere with the operation portion before moving to the second cover position.

According to the configuration described above, in the state in which the operation portion is located at the unlocked position, the second cover interferes with the operation portion, so that the second cover cannot be displaced to the second cover position. A concern that the operation portion located at the unlocked position is used can therefore be reduced.

The recording apparatus according to any one of [8] to described above may further include a detector configured to detect whether the second cover is open or closed.

According to the configuration described above, the detector detects whether the second cover is open or closed. A concern that the second cover not located at the second cover position is used can therefore be reduced.

In the recording apparatus according to any one of [8] to described above, the second cover may include a reader configured to read an image of a document.

According to the configuration described above, the second cover includes the reader. The size of the apparatus can therefore be reduced as compared with a case where the reader is separately provided.

The recording apparatus according to any one of [1] to described above may further include a maintenance portion configured to perform maintenance of the recording portion, the recording portion may be a liquid ejector configured to eject liquid, and the loaded member may be a waste liquid storing body configured to store waste liquid collected by the maintenance portion.

According to the configuration described above, the cover covers the waste liquid storing body. The operability of the cover is improved as described in [1]. A concern that it takes time for the user to detach the cover so that the user inadvertently touches the waste liquid storing body can therefore be reduced.

What is claimed is:

1. A recording apparatus comprising:
a recording portion configured to perform recording on a medium;
a loading portion having a loading space into which a loaded member is loadable; and
a cover displaced from a non-cover position at which the cover does not cover the loading space to a cover position at which the cover covers the loading space when caused to slide in a first direction, and displaced from the cover position to the non-cover position when caused to slide in a direction opposite the first direction,
the cover includes
an operation portion that is movable in the first direction and the direction opposite the first direction when externally operated, and
an engager engageable with an engagement receiver provided in the loading portion, and
the engager moves to an engagement position at which the engager is engageable with the engagement receiver when the operation portion is moved in the first direction, and moves to a non-engagement position at which the engager is not engageable with the engagement receiver when the operation portion is moved from the engagement position in the direction opposite the first direction.

2. A recording apparatus comprising:
a recording portion configured to perform recording on a medium;
a loading portion having a loading space into which a loaded member is loadable; and
a cover displaced from a non-cover position at which the cover does not cover the loading space to a cover position at which the cover covers the loading space when caused to slide in a first direction, and displaced from the cover position to the non-cover position when caused to slide in a direction opposite the first direction,
the cover includes
an operation portion movable to a locked position and an unlocked position when externally operated, and
an engager engageable with an engagement receiver provided in the loading portion,
the engager is located at an engagement position at which the engager is engageable with the engagement receiver when the operation portion is located at the locked position, and is located at a non-engagement position at which the engager is allowed to disengage from the engagement receiver when the operation portion is located at the unlocked position, and
the loading portion includes a pusher urged in the direction opposite the first direction and configured to push the cover located at the cover position.

3. The recording apparatus according to claim 2, wherein
the operation portion moves to the locked position when moved in a second direction different from the first direction, and to the unlocked position when moved in a direction opposite the second direction.

4. The recording apparatus according to claim 1, wherein
the engager moves to the engagement position and the non-engagement position when moved in the first direction and the direction opposite the first direction, respectively.

5. The recording apparatus according to claim 1, wherein
the engager moves to the engagement position and the non-engagement position when moved in a second direction different from the first direction and a direction opposite the second direction, respectively.

6. The recording apparatus according to claim 1, wherein
the engager moves to the engagement position and the non-engagement position when caused to pivot.

7. The recording apparatus according to claim 1, wherein
the cover moving from the non-cover position in the first direction in a state in which the engager is located at the engagement position interferes with the loading portion before moving to the cover position.

8. The recording apparatus according to claim 1, wherein
the cover is called a first cover, the cover position is called a first cover position, and the non-cover position is called a first non-cover position,
the recording apparatus further comprises a second cover,
the second cover is displaceable to a second cover position at which the second cover covers an interior of the apparatus, and a second non-cover position at which the second cover does not cover the interior of the apparatus,
at least a portion of the first cover located at the first cover position overlaps with at least a portion of the second cover located at the second cover position, and
the second cover is located above the first cover.

9. The recording apparatus according to claim 8, wherein
when the first cover is located at the first cover position, and the second cover is located at the second cover position, at least a portion of the operation portion overlaps with the second cover.

10. The recording apparatus according to claim 9, wherein
in a state in which the first cover is located at the first cover position, and the operation portion is located at the unlocked position, the second cover moving from the second non-cover position to the second cover position interferes with the operation portion before moving to the second cover position.

11. The recording apparatus according to claim 10, further comprising a detector configured to detect whether the second cover is open or closed.

12. The recording apparatus according to claim 8, wherein
the second cover includes a reader configured to read an image of a document.

13. The recording apparatus according to claim 1, further comprising
a maintenance portion configured to perform maintenance of the recording portion,
wherein the recording portion is a liquid ejector configured to eject liquid, and
the loaded member is a waste liquid storing body configured to store waste liquid collected by the maintenance portion.
